(19) United States
(12) Patent Application Publication
(10) Pub. No.: US 2020/0223279 A1
(43) Pub. Date: Jul. 16, 2020

(54) ANTI-ROLL BAR WITH HEAVE SPRING OR ACTUATOR

(71) Applicant: NIO USA, Inc., San Jose, CA (US)

(72) Inventor: Martin J. McKeefery, San Jose, CA (US)

(21) Appl. No.: 16/244,801

(22) Filed: Jan. 10, 2019

(51) Int. Cl. B60G 21/055

(52) U.S. Cl. CPC B60G 21/0555; B60G 2202/135; B60G 2206/427; B60G 2202/42

(57) ABSTRACT

A suspension system for use in vehicles includes a heave spring and an anti-roll bar. The system architecture allows for the ride spring rate and the wheel spring rates to be decoupled, such that each can be independently tuned. Furthermore, the suspension system may be fully active, quasi-fully active, semi-active, or passive.

### FIELD

The present disclosure is generally directed to vehicle suspension systems, and in particular, toward a vehicle suspension system including an anti-roll bar and heave spring and/or an actuator.

### BACKGROUND

Conventional vehicle suspension includes an anti-roll bar and corner springs. The anti-roll bar connects the left of the vehicle's suspension to the right side with a torsion spring, this torsion spring reduces the amount of body roll. The corner springs provide the force needed to support the vehicle, in ride height, pitch and jounce.

In some suspension systems, a combined tramp rod and anti-roll bar is secured between a rear axle beam and the chassis of a vehicle. The combined tramp rod and anti-roll bar has an intermediate portion, a right arm, and a left arm that are connected by bushings to either the rear axle beam or the frame of the vehicle. This provides roll stiffness control and also resists wind-up of the rear axle when high torque loads are applied to the rear axle. An example of a combined tramp rod and anti-roll bar is shown in U.S. Pat. No. 8,033,556, the entire disclosure of which, except for any definitions, disclaimers, disavowals, and inconsistencies, is incorporated herein by reference.

### BRIEF DESCRIPTION OF THE DRAWINGS

FIG. 1 shows a vehicle in accordance with embodiments of the present disclosure;

FIG. 2 shows a traditional suspension system for a vehicle;

FIG. 3A shows an anti-roll bar assembly for use in a suspension system in accordance with embodiments of the present disclosure;

FIG. 3B shows an anti-roll bar assembly for use in a suspension system in accordance with another embodiment of the present disclosure;

FIG. 3C shows an anti-roll bar assembly for use in a suspension system in accordance with yet another embodiment of the present disclosure;

FIG. 4A shows an anti-roll bar assembly in accordance with embodiments of the present disclosure;

FIG. 4B shows the anti-roll bar assembly of FIG. 4A in accordance with another embodiment of the present disclosure;

FIG. 5 shows a vehicle suspension system in accordance with embodiments of the present disclosure;

FIG. 6 shows a vehicle suspension system in accordance with another embodiment of the present disclosure; and

FIG. 7 shows a vehicle suspension system in accordance with yet another embodiment of the present disclosure.

### DETAILED DESCRIPTION

Embodiments of the present disclosure will be described in connection with a vehicle suspension system.

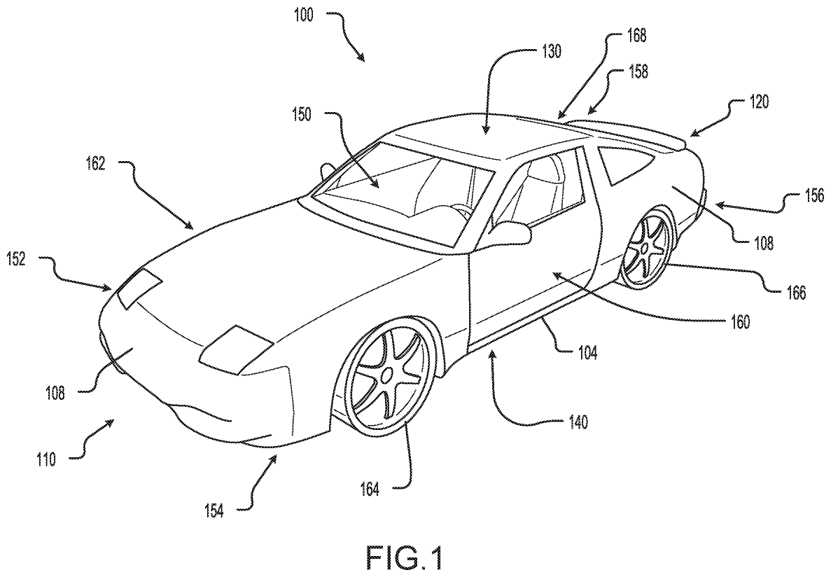

FIG. 1 shows a perspective view of a vehicle 100 in accordance with embodiments of the present disclosure. The vehicle 100 comprises a vehicle front 110, vehicle aft 120, vehicle roof 130, at least one vehicle side 160, a vehicle undercarriage 140, a vehicle interior or cabin 150, front wheels 162, 164, rear wheels 166, 168, and corners 152, 154, 156, 158. The vehicle 100 may include a frame 104 and one or more body panels 108 mounted or affixed thereto. The vehicle 100 may include one or more interior components (e.g., components inside an interior space or cabin 150, or user space, of a vehicle 100, etc.), exterior components (e.g., components outside of the interior space or cabin 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, buses, automobiles, trains, railed conveyances, boats, ships, marine conveyances, submarine conveyances, airplanes, space craft, flying machines, human-powered conveyances, and the like.

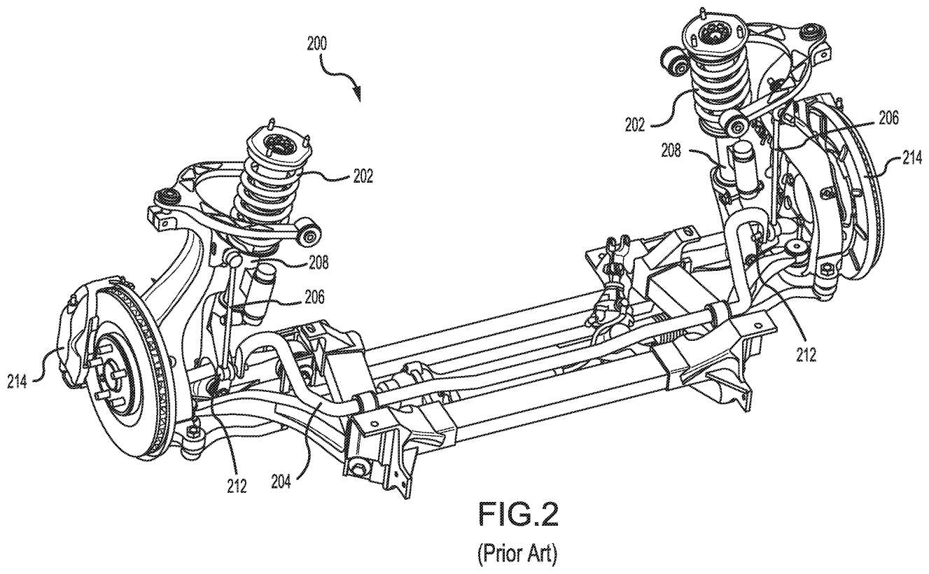

FIG. 2 shows a traditional suspension system 200 including a corner spring 202 and an anti-roll bar 204. The anti-roll bar 204 is connected at each end thereof to a corner spring 202 by means of a drop link 206. A fastener or other connection device 212 connects the drop link 206 to the anti-roll bar 204. Each corner spring 202 may sit atop a damper 208. The corner springs 202 support the corners 152, 154 of the vehicle 100 (if the suspension system 200 is positioned between the front wheels 162, 164 of the vehicle 100) or the corners 156, 158 of the vehicle 100 (if the suspension system 200 is positioned between the rear wheels 166, 168 of the vehicle 100).

The drop links 206 in FIG. 2 may also be referred to as “stabilizer links,” “anti-roll bar links,” and “sway bar links.” The drop links 206 connect the left and/or right-hand suspension corner springs 202 to the ends of the anti-roll bar 204. The drop links 206 may be made of metal or plastic rods with a ball joint on either or both ends.

The anti-roll bar 204 reduces or prevents body roll when a corner spring 202 on one side of the suspension system 200 compresses but the corner spring 202 on the other side does not (as might occur, for example, if the wheel 162 hits a corner bump but the wheel 164 does not). In this case, the compression of the corner spring 202 located nearest the wheel 162 causes the drop link 206 to pull up on the attached end of the anti-roll bar 204, thus imposing torque on the anti-roll bar 204. This torque is transferred through the anti-roll bar 204 and causes the anti-roll bar 204 to exert an upward force on the drop link 206 on the opposite side of the suspension system 200, thus compressing the corner spring 202 on that side of the suspension system 200. Thus, the compression of one corner spring 202 causes compression of the opposite corner spring 202, which reduces the roll of the vehicle 100.

Referring still to FIG. 2, the dampers 208 extend between a chassis of the vehicle 100 and the suspension system 200, in parallel with the corner springs 202. The dampers 208 may also be referred to as struts or shock absorbers and may be of the type shown in U.S. Pat. No. 8,534,687, the entire disclosure of which, except for any definitions, disclaimers, disavowals, and inconsistencies, is incorporated herein by reference. The dampers 208 may be composed of metal or a metal alloy such as steel.

In some embodiments, the suspension system 200 may include a post rather than a damper 208. In such embodiments, the post does not include any damping. The post may be made of carbon fiber, very long fiber, or a structural plastic material.

The suspension system 200 pictured in FIG. 2 is a front suspension system positioned between the front wheels 162, 164 of the vehicle 100, each of which is connected to the wheel hub 214 on the corresponding side of the suspension system 200.

An identical or similar suspension system 200 may also be a rear suspension system positioned between and connected to the rear wheels 166, 168 of the vehicle 100. Where the suspension system 200 is used as a rear suspension system, the corner springs 202 support the rear corners 156, 158 of the vehicle 100.

As described above, with a traditional suspension system 200, the roll rate of the vehicle 100 is controlled by the anti-roll bar 204. More specifically, a downward force on one corner spring 202—caused, for example, by lateral acceleration as the vehicle 100 turns a corner—is transmitted from the corner spring 202 through a drop link 206 to the anti-roll bar 204. The anti-roll bar 204 transmits a percentage of that force to the opposite drop link 206 and corner spring 202, thus forcing the opposing corner spring 202 to compress and decreasing the roll of the vehicle 100. Depending on the torsional stiffness of the anti-roll bar 204, the percentage of transferred force may be higher (for stiffer anti-roll bars 204) or lower (for less stiff anti-roll bars 204). Thus, increasing the torsional stiffness of the anti-roll bar 204 will decrease the roll rate of the vehicle 100, and decreasing the torsional stiffness of the anti-roll bar 204 will increase the roll rate of the vehicle 100.

While the roll rate of the vehicle 100 having a suspension system 200 is controlled by the anti-roll bar 204, the ride rate, coupled with the corner rate, of the vehicle 100 is controlled with the corner springs 202. More specifically, because the corner springs 202 support the weight of the vehicle 100 and also react to unequal forces imposed on each side of the vehicle 100, the spring rate of the corner springs 202 determines both the ride rate and the corner rate. As a result, any change to the corner springs 202 made to alter the ride rate will affect the corner rate, and vice versa.

The configuration of the suspension system 200, then, reduces the tuning opportunities for the vehicle 100 because the ride rate and corner rate cannot be individually tuned. The present disclosure describes anti-roll bar assemblies that, when used in a suspension system 200 in place of the anti-roll bar 204, decouple the ride rate and the corner rate, thus enabling the ride rate and the corner rate to be individually tuned.

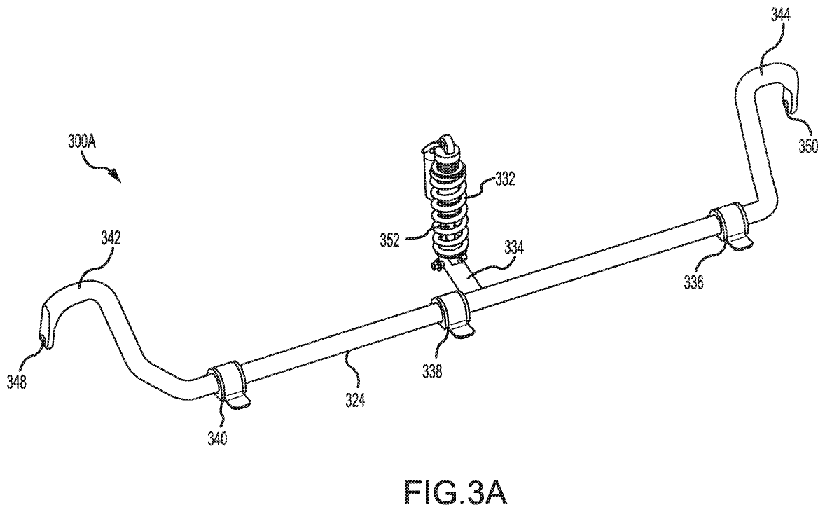

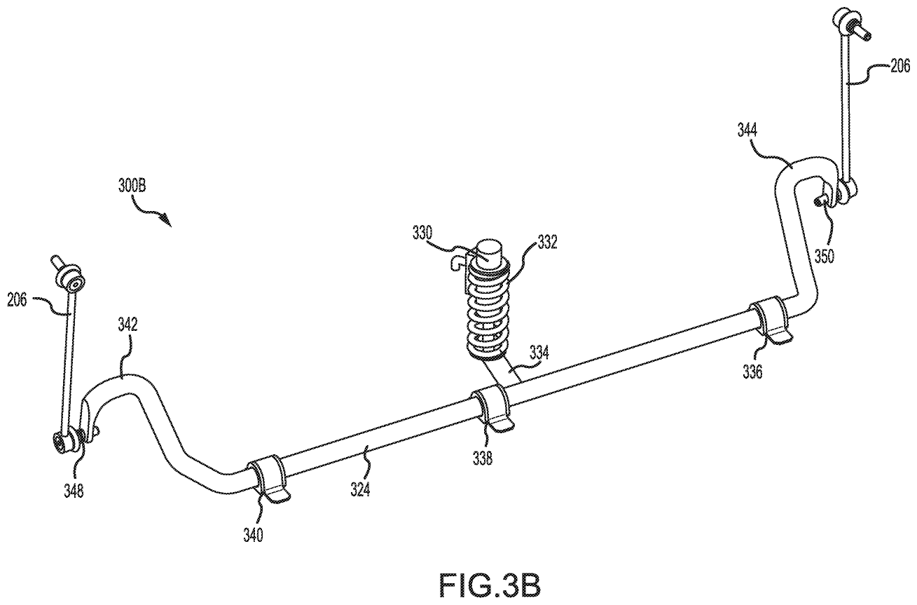

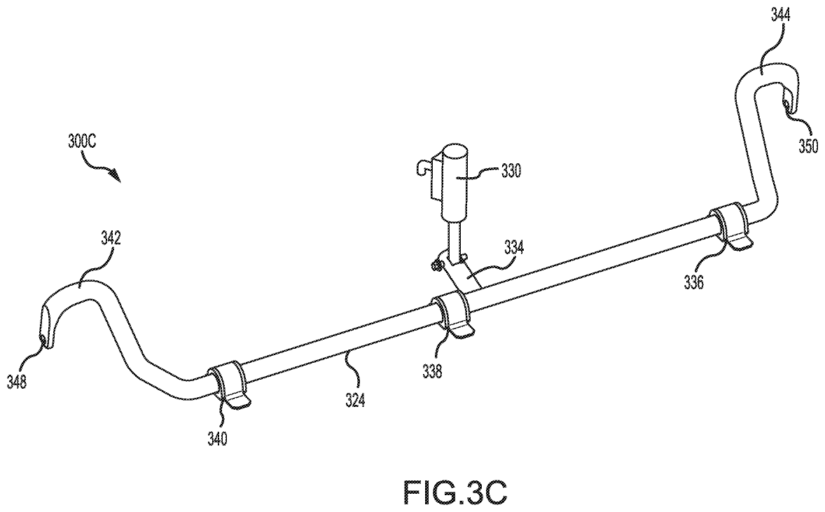

Turning now to FIG. 3A, an anti-roll bar assembly 300A according to embodiments of the present disclosure may be substituted for a traditional anti-roll bar (such as the anti-roll bar 204) in an otherwise traditional suspension system (such as the suspension system 200) to achieve a decoupling of the ride rate and the corner rate. The anti-roll bar assembly 300A may be used in a front suspension system, a rear suspension system, or both, with maximum benefit achieved when the anti-roll bar assembly 300A is used in both the front and rear suspension systems of a vehicle 100.

The anti-roll bar assembly 300A comprises an anti-roll bar 324 with arms 342, 344 at the ends thereof and a lever arm 334 extending from at or near a midpoint thereof. The anti-roll bar assembly 300A further comprises a heave spring 332 and a damper 352 connected to the lever arm 334. The anti-roll bar 324 includes a right support pivot 336 on a right side of the anti-roll bar 324, a left support pivot 340 on a left side of the anti-roll bar 324, and a central support pivot 338 positioned adjacent the lever arm 334. Drop link attachments 348, 350 near the ends of the anti-roll bar 324 provide an attachment point for drop links such as the drop links 206 (e.g., to connect the anti-roll bar 324 to corner springs such as the corner springs 202).

The heave spring 332 may be made of steel but may also be made of any metal or metal composite and can include a surface coating for corrosion resistance and preventing shards from breaking off the spring. The heave spring 332 may have a spring rate selected based on the weight and purpose of the vehicle 100. Depending on the suspension requirements of the vehicle 100, the heave spring 332 may be one of several types of coil spring, such as a linear spring, a dual-rate spring, or a progressive spring. A linear spring may be preferred for a heave spring 332 in some embodiments because linear springs have the same spring rate at all points. In other embodiments, the heave spring 332 may be a progressive spring, which becomes progressively stiffer as the spring compresses, or a dual-rate/variable-rate spring, which is configured to abruptly change spring rate at some point or points along its travel. In other embodiments, the heave spring 332 may be a standard coil springs, which may be preferred because coil springs allow for flexibility with regard to variable rate characteristics.

In some embodiments, the heave spring 332 may be a leaf spring. Leaf springs are comprised of one of more lengths of arched material called leaves. In some embodiments, the heave spring 332 may be a single leaf or heave spring 332 may be split leaves. Generally, leaf springs are bolted directly to the axle. This allows the leaf spring to support the weight of the vehicle 100 while securing the axle to the frame of vehicle 100. Leaf springs are simple to set up and have few moving parts, making them highly resistant to wear.

The heave spring 332 may also comprise spring seats (top and bottom rubber insulators), upper and lower coil spring mounting brackets, and/or adjusters/shims, which provide additional support or adjustment to the original mounting position. The heave spring 332 may also comprise spacers and leveling kits.

The anti-roll bar 324, which may also be called a “sway bar” or an “anti-sway bar,” reduces the body roll/body lean of the vehicle 100. The stiffness of the anti-roll bar 324 may be selected to achieve a desired amount of load transfer from one side of the anti-roll bar 324 to the other side of the anti-roll bar 324, and thus to adjust the oversteer or understeer of the vehicle 100. The anti-roll bar 324 may be a cylindrical bar formed into a U-shape, as shown. The anti-roll bar 324 may be formed out of steel, aluminum, titanium, carbon fiber, or any other material known in the art that provides the desired stiffness.

In some embodiments, the effective torsional stiffness of the anti-roll bar 324 may be adjustable from outside the vehicle 100 (e.g., by a mechanic), while in other embodiments the torsional stiffness of the anti-roll bar 324 may be adjustable while the vehicle 100 is in use, by way of controls accessible to a driver of the vehicle 100. The adjustment may be accomplished by increasing or reducing the length of the arms 342, 344 of the anti-roll bar 324 or by toggling a switch from a stiff position to a more flexible position.

The support pivots 336, 338, and 340 may be rotatably attached to the anti-roll bar 324 and secured to a chassis of the vehicle 100. Under certain load conditions, the heave spring 332 may cause a bending load in the anti-roll bar 324. Such a load may reduce the effectiveness of the heave spring 332. Accordingly, the support pivots 336, 338, and 340 are included in some embodiments of the present invention to prevent undesirable bending loads in the anti-roll bar 324.

The lever arm 334 is an arm extending from the anti-roll bar 324 to the end of which the heave spring 332 is attached. The lever arm 334 is attached near the midpoint of the anti-roll bar 324, and provides an offset for the heave spring 332. The off-axis position of the heave spring 332 (at the end of the lever arm 334) enables the heave spring 332 to exert a torque on the anti-roll bar 324. The length of the lever arm 334 can be varied to adjust the moment applied to the anti-roll bar 324 by the heave spring 332.

FIG. 3B depicts an anti-roll bar assembly 300B, which includes the drop links 206 that connect to the anti-roll bar 324 via drop link attachments 348, 350. Drop links 206 connect the anti-roll bar 324 to corner springs such as the corner springs 202. In addition, anti-roll bar assembly 300B includes an actuator 330 operably connected to the heave spring 332. The active actuator 330 is positioned in-line with the heave spring 332. The actuator 330, which may be any actuator known in the art, including those discussed herein, allows for active control of ride height changes of the vehicle 100. More specifically, the actuator 330 can actively manipulate the heave spring 332 by adding or subtracting force to change the ride height of the vehicle 100.

The actuator 330 can be used to create a fully active or semi-active suspension system. Active suspension controls the relative movement of the wheels using a controller (not shown) and the actuator 330 to independently raise and lower the chassis of the vehicle 100. In such an embodiment the actuator 330 can exert independent force on the suspension system 200. The actuator 330 may be hydraulically actuated, electronically controlled, or electromagnetically recuperative.

During operation, the actuator 330 receives a control signal and energy from a controller (not shown). The controller can be a fixed mechanical system, an electronic system, a software-based system, a human input-based system or any combination thereof. The controller may include a processor configured to receive inputs from one or more sensors in a suspension system and control the actuator(s) based on those inputs. The control signal may be a low energy signal, or alternatively, the control signal may be in the form of an electric voltage or current, pneumatic or hydraulic pressure. When the actuator 330 receives a signal from the controller, the actuator 330 converts the signal into some mechanical action. Energy for this mechanical action may come from the same or a different controller or energy source.

The actuator 330 may be a hydraulic, pneumatic, electric, twisted coil polymer (TCP) or supercoiled polymer (SCP), thermal, magnetic, or mechanical actuator. In embodiments where the actuator 330 is an electronic actuator, the actuator 330 may be powered by an electric motor that converts electrical energy into mechanical action. The electric motor can cause an increase or decrease in the spring rate of the heave spring 332, as determined by the controller.

In embodiments where the actuator 330 is a hydraulic actuator, the actuator 330 may include a cylinder or fluid motor that uses hydraulic power and converts it into mechanical action. The mechanical action can be linear, rotatory or oscillatory motion. Hydraulic actuators can exert a large force but have limited acceleration.

In embodiments where the actuator 330 is a pneumatic actuator, the actuator 330 uses a vacuum or compressed air to create mechanical action. Pneumatic actuators quickly respond to starting and stopping and are safer, cheaper, and often more reliable and powerful than other actuators.

In embodiments where the actuator 330 is a mechanical actuator, the corner spring actuators converts one motion, such as rotary motion, into another kind of motion, such as linear motion.

In embodiments where the actuator 330 is a twisted and coiled polymer (TCP) actuator, sometimes called a supercoiled polymer (SCP) actuator, the TCP actuator has the shape of a coil spring and can be controlled with electrical energy though Joule heating. TCP actuators are generally constructed from nylon with an electrically conductive coating.

In some embodiments, one or both of the corner springs in a suspension system (such as the corner springs 202 in the suspension system 200) may also comprise an actuator, which may be the same as or similar to the actuator 330.

FIG. 3C depicts an anti-roll bar assembly 300C. According to some embodiments of the present disclosure, an actuator, such as actuator 330, works independently without the use of a heave spring 332 or other spring.

It will be appreciated that any actuator can work independently of a spring or damper. For example, actuator 330 can replace the heave spring 332. The actuator 330 may apply independent force to the heave spring 332 or to the suspension system itself. A spring or damper is not required in addition to an actuator. A suspension system, such as the suspension system 300A, may include only a heave spring 332, or a heave spring 332 and damper 352. A suspension system, such as the suspension system 300B, may include both a heave spring 332 and an actuator 330. And a suspension system, such as the suspension system 300C, may include only an actuator 330.

When used in place of a typical anti-roll bar 204 in a suspension system, such as the suspension system 200, the anti-roll bar assemblies 300A, 300B, and 300C of the present disclosure decouple the ride rate and the corner rate, beneficially allowing these two rates to be tuned individually. More specifically, the heave spring 332 and/or actuator 330 may support the entire weight (or any percentage of the entire weight) of the vehicle 100. As a result, the reaction of the vehicle 100 to a parallel bump (e.g., where both front wheels 162, 164 of the vehicle 100 contact a bump simultaneously, or where both rear wheels 166, 168 of the vehicle 100 contact a bump simultaneously) may be tuned by adjusting the spring rate of the heave spring 332. However, because the heave spring 332 and/or actuator 330 are located mid-span of the anti-roll bar 324, approximately in the middle of the vehicle 100, the heave spring 332 has little if any effect on the corner rate, which is determined entirely or almost entirely by the corner springs 202. Consequently, the reaction of the vehicle 100 to a corner bump (e.g., where only one of the wheels 162, 164, 166, 168 contacts a bump) may be tuned by adjusting the spring rate of the corner spring(s) 202.

The configuration of the anti-roll bar assemblies 300A, 300B, and 300C, with the heave spring 332 and/or actuator 330 connected to the lever arm 334 extending from the anti-roll bar 324, imposes a symmetric force on each corner 152, 154 (for front suspensions) and on each corner 156, 158 (for rear suspensions) of the vehicle 100, through the torsion of the anti-roll bar 324. Although the heave spring 332 and/or actuator 330 do influence the anti-roll bar 324, the anti-roll bar 324 still functions as a typical anti-roll bar by transferring a force imposed on one end thereof by a first corner spring 202/drop link 206 to the drop link 206/corner spring 202 on the other end thereof. Moreover, while traditional anti-roll bars are undamped, the heave spring 332 in some embodiments of the present disclosure may be provided with a damper, which gives the anti-roll bar 324 damping characteristics.

The heave spring 332 also affects the pitch moment during braking and acceleration. The pitch moment of the vehicle 100 can be adjusted by adjusting the primary spring rate of the heave spring 332 (whether by replacing one heave spring 332 having a first primary spring rate with a second heave spring 332 having a second primary spring rate, or by controlling an actuator 330 to adjust the primary spring rate of the heave spring 332 without replacing the heave spring 332). Where a heave spring 332 is used on both front and rear suspensions of the vehicle 100, greater control may be exercised over the pitch moment of the vehicle 100 by tuning the front and rear heave springs 332.

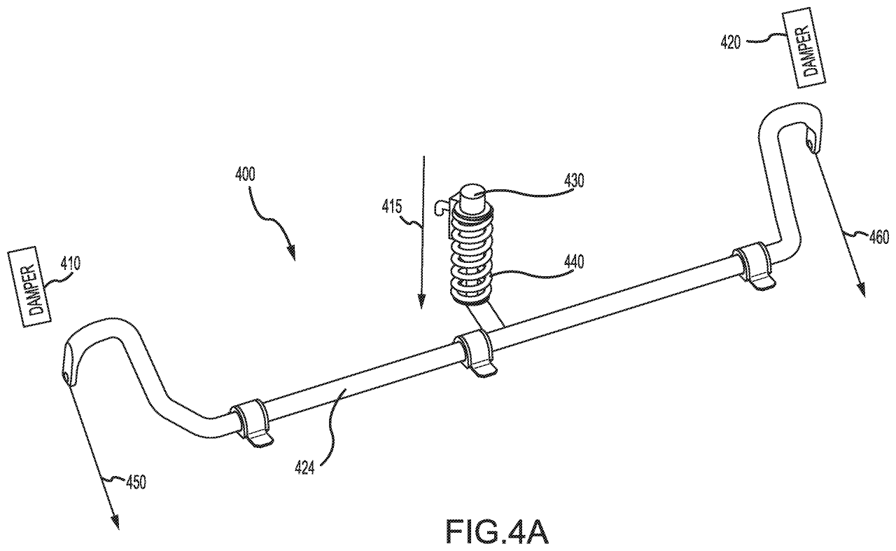

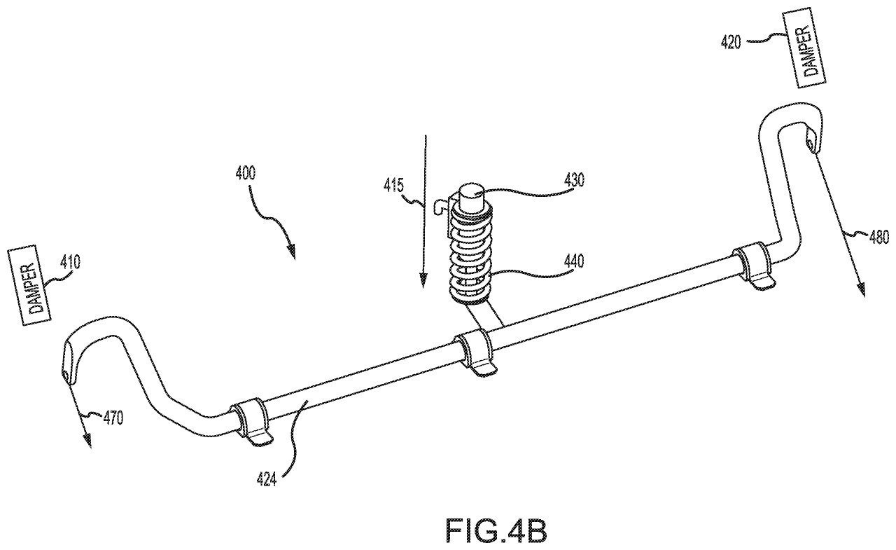

FIGS. 4A and 4B depict the forces that may be exerted on and/or by an anti-roll bar assembly 400 in use. The anti-roll bar assembly 400 may be the same as or substantially similar to the anti-roll bar assembly 300A, 300B, or 300C. In FIG. 4A, corner dampers 410 and 420 of the suspension system in which the anti-roll bar assembly 400 is used are shown in block form. (No other components of the overall suspension system, including corner springs such as the corner springs 202, are shown in FIGS. 4A and 4B). If such corner dampers 410, 420 have semi-active damping control, the rate of vehicle lifting with the active heave spring 440 (e.g., the heave spring 440 coupled with the actuator 430) can be biased from left to right, ultimately creating a quasi-fully-active suspension system. Said another way, the heave spring 440 and/or the actuator 430 can provide similar benefits as a fully active suspension but in an indirect manner.

In the embodiment shown in FIGS. 4A and 4B, the anti-roll bar assembly 400 includes the dampers 410, 420 with semi-active damping control. In FIG. 4A, a force 415 exerted by the actuator 430 on the heave spring 440 is distributed evenly to the front corners 152, 154 (or back corners 156, 158, if the anti-roll bar assembly 400 is installed on the rear of a vehicle 100) of the vehicle 100. This force is transmitted through the anti-roll bar 424 to drop links such as the drop links 206, which in turn transmit the force to the dampers 410, 420 and/or corner springs such as the corner springs 202. With both dampers 410, 420 in an open configuration (e.g., a configuration in which the dampers 410, 420 may be compressed or extended relatively easily), the forces 450, 460 exerted by the anti-roll bar 424 on the drop links or other connector mechanism are equal. Such a configuration of the anti-roll bar assembly 400 and dampers 410, 420 may be beneficial when the vehicle 100 experiences a parallel bump, where the road exerts approximately equal force on the front wheels 162, 164 or the rear wheels 166, 168 that are connected to suspension system on which the anti-roll bar assembly 400 is installed.

Referring to FIG. 4B, the active force 415 exerted by the actuator 430 on the heave spring 440 is again transmitted via the anti-roll bar 424. However, the damper 410 is in a stiff, locked-down configuration (in which damper 410 is resistant to compression or extension), while the damper 420 remains in the open configuration. As a result, the damper 410 effectively exerts an upward force on the anti-roll bar 424, which results in an overall net downward force 470 that is smaller than the net downward force 480, which is not offset by an upward force (or by as strong of an upward force) exerted by the damper 420. This configuration of the anti-roll bar assembly 400 and the dampers 410, 420 may be particularly useful, for example, when the vehicle 100 experiences a corner bump, where the road exerts an unequal force on the front wheels 162, 164 or the rear wheels 166, 168.

As shown by the alternative configurations in FIGS. 4A and 4B, the ability to lock down the dampers 410, 420, in connection with the use of an actuator 430 with the heave spring 440, allows for quasi-fully-active control of the suspension system in which the anti-roll bar assembly 400 is installed. In some embodiments, the semi-active dampers 410, 420 may respond to any force differential by changing the damping orifice size of hydraulic dampers. The dampers 410, 420 may be electronically controlled to respond in real-time to changing conditions.

Suspension systems in which an anti-roll bar assembly of the present disclosure—such as the anti-roll bar assemblies 300A, 300B, 300C, and 400 described above—may be installed may have the same arrangement as the suspension system 200 of FIG. 2, or an alternative arrangement. For example, the drop link 206 may be placed horizontally or at an angle as compared to the vertical configuration shown in FIG. 2. Similarly, the corner springs 202, and the anti-roll bar 324 may be placed at different angles or attached at a different location than shown.

In addition, a suspension system in which an anti-roll bar assembly 300A, 300B, 300C, or 400 is installed may include corner spring actuators. The corner spring actuators can be used to create a truly fully active system. The use of both an actuator 330/430 and corner spring actuators would allow for on-the-go tuning of the vehicle ride rate and pitch moment (using the actuator 330/430) and of the vehicle corner rate (using the corner spring actuators). However, because most of the benefits of a fully active suspension system may be achieved by the use of a heave spring 332/440 coupled with an actuator 330/430 and semi-active dampers 410, 420, as shown above, in some embodiments no corner spring actuators are included.

Corner spring actuators can work independently of corner springs 202 or dampers 410 and 420. For example, corner spring actuators can replace the corner springs 202 or dampers 410 and 420. It is not required to have a spring or damper and an actuator. A suspension system may include only corner springs 202, only dampers 410 and 420, only corner spring actuators, or any combination thereof. In other embodiments, a suspension system comprising an anti-roll bar assembly 300A, 300B, 300C, and 400 may be a passive suspension system, with no actuator 330/430, no corner spring actuator, and no active or semi-active dampers. In yet another embodiment, a suspension system comprising an anti-roll bar assembly 300A, 300B, 300C, and 400 may be an active suspension system, wherein the suspension system varies the firmness of the shock absorbers (e.g., dampers 208) depending on road conditions.

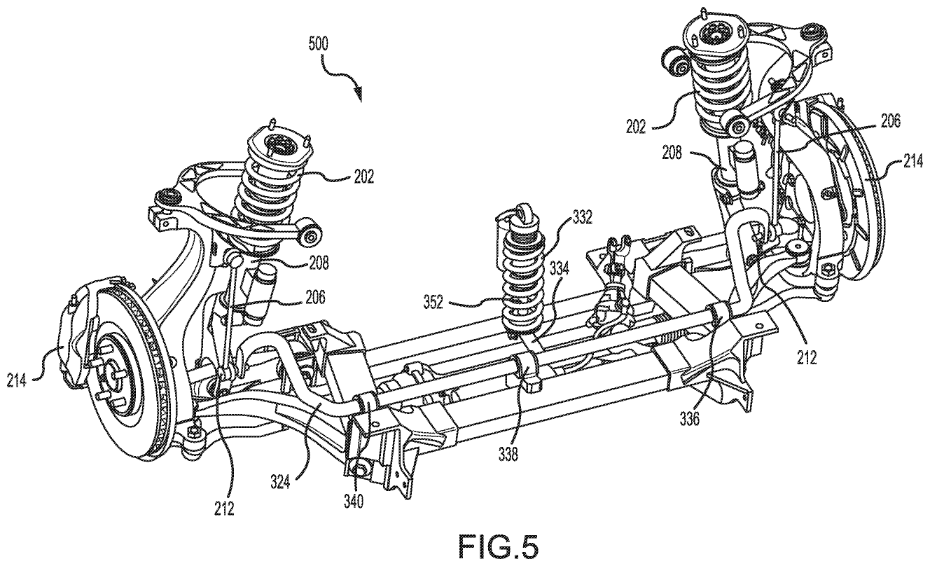

FIGS. 5, 6, and 7 each depict an embodiment of a suspension system. FIG. 5 depicts the suspension system 500, which resembles the suspension system 200, with the addition of an anti-roll bar assembly 300A. The anti-roll bar 324 includes a right support pivot 336 on a right side of the anti-roll bar 324, a left support pivot 340 on a left side of the anti-roll bar 324, and a central support pivot 338 positioned adjacent a lever arm 334. A heave spring 332 sits above the lever arm 334, and an optional damper 352 is connected to the lever arm 334.

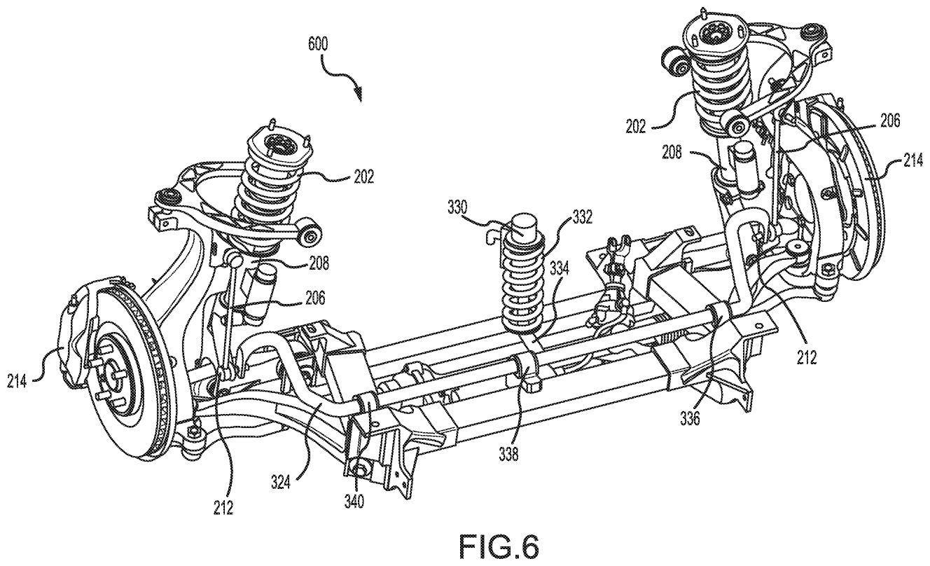

FIG. 6 depicts another embodiment of the present disclosure. According to FIG. 6, the suspension system 600 includes the heave spring 332 and the actuator 330. The actuator 330 and the heave spring 332 are connected to the lever arm 334.

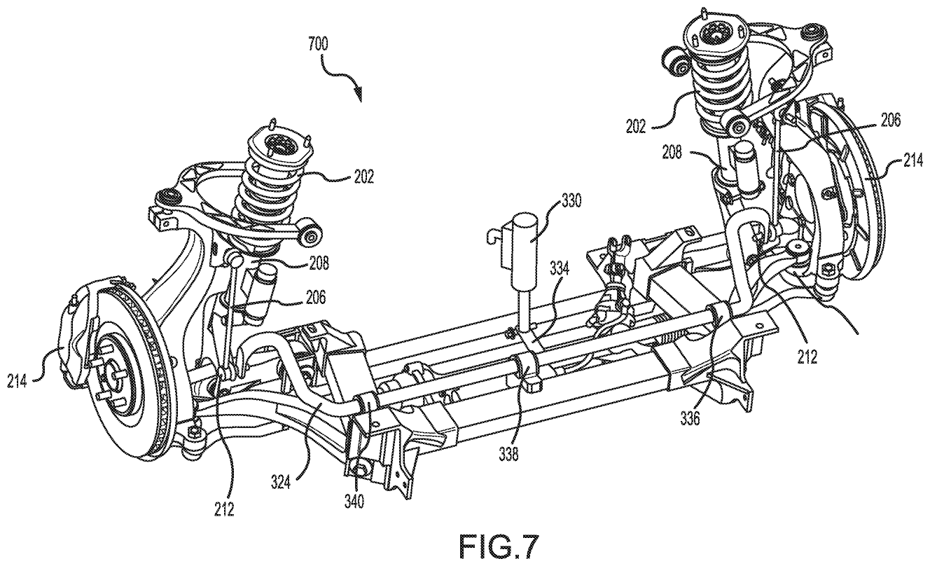

FIG. 7 depicts another embodiment of the present disclosure. In this embodiment, the suspension system 700 includes an independent actuator 330 connected to the lever arm 334. The actuator 330 works independently of any heave spring or damper to provide fully active or semi-active damping. The actuator 330 connects to the lever arm 334 at one end, and the vehicle frame (not shown) at the other end. The actuator 330, which may be a hydraulic, pneumatic, electric, twisted coil polymer (TCP) or supercoiled polymer (SCP), thermal, magnetic, or mechanical actuator, can fully or partially support the weight of a vehicle, such as vehicle 100. The exemplary systems and methods of this disclosure have been described in relation to a vehicle suspension system. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a system for a vehicle, comprising: a pair of corner springs; a pair of dampers, each corresponding to one of the pair of corner springs; an anti-roll bar configured to control a vehicle's roll rate, the anti-roll bar in force-transmitting communication with each of the pair of corner springs; a lever arm attached near a midpoint of the anti-roll bar; and a biasing member attached to the lever arm, the biasing member comprising at least one damper.

Aspects of the above system include: an actuator in-line with the biasing member, wherein the biasing member comprises a heave spring; the actuator is operable to control a ride height of the vehicle; each of the pair of dampers is a semi-active damper; the anti-roll bar has damping characteristics; the biasing member comprises an actuator; the actuator is operable to control a ride height of the vehicle.

A suspension system, comprising: an anti-roll bar; a plurality of support pivots positioned on the anti-roll bar; a lever arm extending from a midpoint of the anti-roll bar; a heave spring attached to the lever arm, the heave spring configured to decouple a ride rate of a vehicle from a corner rate of the vehicle; and an active element associated with the heave spring, wherein the active element can add or subtract force applied to the heave spring to change a ride height of the vehicle.

Aspects of the above system include: a first corner spring associated with the anti-roll bar, and a first drop link in force-transmitting communication between a first end of the anti-roll bar and the first corner spring; a second corner spring associated with the anti-roll bar, and a second drop link in force-transmitting communication between a second end of the anti-roll bar and the second corner spring; a first damper associated with the first corner spring and a second damper associated with the second corner spring; the first damper and the second damper are adjustable in real time; a first actuator associated with the first corner spring and a second actuator associated with the second corner spring, wherein the first actuator and the second actuator are capable of applying a force to one or both of the first corner spring and the second corner spring; the system is a fully active suspension system; the system is quasi fully-active suspension system.

A vehicle comprising: a body; and a suspension system comprising: a sway bar comprising a lever arm; a heave spring extending between the body and the lever arm, the heave spring supporting the body above the sway bar; a heave spring actuator operably connected to the heave spring; a heave spring damper associated with the heave spring; a first corner spring in force-transmitting communication with the sway bar via a first drop link; and a second corner spring in force-transmitting communication with the sway bar via a second drop link.

Aspects of the above system include: at least one sensor located on the vehicle; a heave spring actuator controller capable of receiving a signal from the at least one sensor and capable of sending a signal and electrical energy to the heave spring actuator; a corner spring actuator controller capable of receiving a signal from the at least one sensor and capable of sending a signal and electrical energy to the first actuator and the second actuator; a first damper associated with the first corner spring; a second damper associated with the second corner spring; a first actuator associated with the first corner spring; and a second actuator associated with the second corner spring.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

The terms “determine,” “calculate,” “compute,” and variations thereof, as used herein, are used interchangeably and include any type of methodology, process, mathematical operation or technique.

What is claimed is:

1. A suspension system for a vehicle, comprising:
a pair of corner springs;
a pair of dampers, each corresponding to one of the pair of corner springs;
an anti-roll bar configured to control a vehicle's roll rate, the anti-roll bar in force-transmitting communication with each of the pair of corner springs;
a lever arm attached near a midpoint of the anti-roll bar; and
a biasing member attached to the lever arm, the biasing member comprising at least one damper.

2. The system of claim 1, further comprising an actuator in-line with the biasing member, wherein the biasing member comprises a heave spring.

3. The system of claim 2, wherein the actuator is operable to control a ride height of the vehicle.

4. The system of claim 1, wherein each of the pair of dampers is a semi-active damper.

5. The system of claim 4, wherein the anti-roll bar has damping characteristics.

6. The system of claim 1, wherein the biasing member comprises an actuator.

7. The system of claim 6, wherein the actuator is operable to control a ride height of the vehicle.

8. A suspension system, comprising:
an anti-roll bar;
a plurality of support pivots positioned on the anti-roll bar;
a lever arm extending from a midpoint of the anti-roll bar;
a heave spring attached to the lever arm, the heave spring configured to decouple a ride rate of a vehicle from a corner rate of the vehicle; and
an active element associated with the heave spring, wherein the active element can add or subtract force applied to the heave spring to change a ride height of the vehicle.

9. The system of claim 8, further comprising a first corner spring associated with the anti-roll bar, and a first drop link in force-transmitting communication between a first end of the anti-roll bar and the first corner spring.

10. The system of claim 9, further comprising a second corner spring associated with the anti-roll bar and a second drop link in force-transmitting communication between a second end of the anti-roll bar and the second corner spring.

11. The system of claim 10, further comprising a first damper associated with the first corner spring and a second damper associated with the second corner spring.

12. The system of claim 11, wherein the first damper and the second damper are adjustable in real time.

13. The system of claim 10, further comprising a first actuator associated with the first corner spring and a second actuator associated with the second corner spring, wherein the first actuator and the second actuator are capable of applying a force to one or both of the first corner spring and the second corner spring.

14. The system of claim 8, wherein the system is a fully active suspension system.

15. The system of claim 8, wherein the system is quasi fully-active suspension system.

16. A vehicle, comprising:
a body; and
a suspension system comprising:
a sway bar comprising a lever arm;
a heave spring extending between the body and the lever arm, the heave spring supporting the body above the sway bar;
a heave spring actuator operably connected to the heave spring;
a heave spring damper associated with the heave spring;
a first corner spring in force-transmitting communication with the sway bar via a first drop link; and
a second corner spring in force-transmitting communication with the sway bar via a second drop link.

17. The system of claim 16, further comprising at least one sensor located on the vehicle.

18. The system of claim 17, further comprising a heave spring actuator controller capable of receiving a signal from the at least one sensor and capable of sending a signal and electrical energy to the heave spring actuator.

19. The system of claim 17, further comprising a corner spring actuator controller capable of receiving a signal from the at least one sensor and capable of sending a signal and electrical energy to the first actuator and the second actuator.

20. The system of claim 16, further comprising:
a first damper associated with the first corner spring;
a second damper associated with the second corner spring;
a first actuator associated with the first corner spring; and
a second actuator associated with the second corner spring.
